(19) United States
(12) Patent Application Publication
(10) Pub. No.: US 2007/0246446 A1
(43) Pub. Date: Oct. 25, 2007

(54) Continous Butt Welding Method Using Plasma and Laser, and Method for Fabricating Metal Tube Using the Same

(76) Inventors: Sang-Hoon Lee, Seoul (KR); Yong-Hee Won, Seoul (KR); Tae-Seong Kim, Gyeonggi-do (KR); Tae-Jung Lee, Gyeonggi-do (KR); Jung-Hoon Byun, Gyeongsangbuk-do (KR); Suck-Joo Na, Chungcheongnam-do (KR); Suk-Hwan Yoon, Daejeon (KR); Jae-Ryun Hwang, Gyeongsangbuk-do (KR)

Correspondence Address: JONES DAY, 222 EAST 41ST ST, NEW YORK, NY, 10017, US

(21) Appl. No.: 11/629,611

(22) PCT Filed: Jun. 18, 2004
(86) PCT No.: PCT/KR04/01466

§ 371 Date: Dec. 14, 2006

(30) Foreign Application Priority Data
Jun. 14, 2004 (KR) 10-2004-0044724

(51) Int. Cl. B23K 26/00

(52) U.S. Cl. 219/121.64

(57) ABSTRACT

A continuous butt welding method using plasma and laser, and a method for fabricating a metal tube using the butt welding method are disclosed. The butt welding method conducts a laser welding and a plasma welding together against an object to be welded, which has a very narrow butt space. In particular, the plasma is prior to the laser so that the object is preheated by the plasma, and then a preform is melted by a laser beam in order to accomplish the major welding. In addition, a metal sheet is bent to have a circular section so that its both ends are faced with each other, and then the faced both ends are welded using the aforementioned butt welding method, thereby fabricating a metal tube. The butt welding method and the metal tube fabricating method mentioned above remarkably improve a welding speed and productivity of metal tube.

### TECHNICAL FIELD

The present invention relates to a butt welding method of metal materials and a method for fabricating a metal tube using the same, and more particularly to a welding method for improving a welding speed by using two kinds of heat sources together, and a method for fabricating a metal tube using the welding method.

### BACKGROUND ART

Laser welding and arc welding have been widely used to face and weld two metals with each other.

The laser welding has advantages that it is possible to precisely weld a fine part due to its small heat-affected zone because it may focus a heat source (for example, a laser beam) on a very small size, and to conduct seam welding (or, deep penetration welding) by forming a key hole. However, the laser welding has disadvantages that its narrow focal radius makes it difficult to trace a delicate weld line as in the butt welding, and generates pores in the welding portion since it causes the key hole to be unstable. In addition, in the case of the laser welding high-power laser should be used to accelerate a welding flux for improvement of productivity, resulting in serious increase of welding cost.

Meanwhile, Arc welding or plasma welding has advantages of having lower welding defects and capable of easily tracing a weld line, compared to laser welding. However, the arc welding has a disadvantage that it is unsuitable to weld an elaborate product with a narrow butt space (for example, 0.2 mm or less) because it has a large area of the heat source in the welding portion.

In order to solve disadvantages of such two welding methods, welding methods using the laser welding and the arc welding together have been proposed (Japanese Patent Laid-open Publication Nos. 2001-334377 and 2002-346777, U.S. Patent Laid-open Publication No. 2001/0047984 A1, etc.). The Japanese and U.S. Patent Laid-open Publications insist that the method is capable of attaining deep penetration and improving the welding speed, which otherwise could not be attained by only the arc welding, if the laser welding and the arc welding are conducted together. However, using two kinds of heat sources at the same time is not always advantageous. For example the results obtained when two welding methods are used together may be inferior to a simple sum of results obtained by each of the heat sources, depending on a treatment order, a distance, an angle, a power and a welding speed of two heat sources.

Meanwhile, the welding has been used to fabricate a metal tube (so-called a loose tube which is generally made of stainless steel) in which some strands of optical fibers are mounted. That is to say, a metal tube is fabricated by plasticizing a band-shaped metal sheet into a circular section to connect both facing ends with the welding. A very precise welding is required for such a loose tube which has a diameter of 2 to 5 mm and a thickness of 0.1 to 0.2 mm, and a butt space of 0.2 mm or less prior to the welding. Accordingly, laser welding using CO₂ laser is currently used as such a welding method, but it is difficult to improve the productivity of metal tube only by the laser welding, as describe above. That is to say, the welding process may become a bottle-neck operation because a speed of plasticizing the metal sheet into a circular section is faster than the welding speed.

Accordingly, it may be considered to improve the welding speed by using two kinds of heat sources together, as described above in the combined welding method of the laser welding and the arc welding. However, extremely elaborate process conditions should be first satisfied and the heat sources and the process conditions should be selected depending on characteristics of the object to be welded so as to obtain a desired product when two kinds of heat sources are used together, as described above. For example, the combined laser-arc welding as disclosed in the abovementioned Japanese and U.S. Patent Laid-open Publications may be applied to welding a relatively thick plate, in particular a general iron plate other than stainless steel, for example bodies of ship or vehicle, but it may not applied to welding an object having a very small butt space and small thickness.

As mention above, there is urgently required a welding method capable of improving a welding speed and also allowing elaborate welding for butt-welding metal sheets having a very small butt space and small thickness.

### DISCLOSURE OF INVENTION

The present invention is designed to solve the problems of the prior art, and therefore it is an object of the present invention to provide a welding method capable of improving a welding speed and also allowing elaborate welding for an object to be welded having a very small butt space and small thickness.

Also, it is an object of the present invention to provide a method for fabricating a metal tube with a small diameter by butt-welding metal sheets having a very small butt space and small thickness.

In order to accomplish the above object, the welding method according to the present invention conducts laser welding and plasma welding together, and particularly major welding is carried out by aligning the plasma prior to the laser so that a preform (an object to be welded) can be pre-heated with the plasma, and then melted with a laser beam.

Namely, the continuous butt welding method using the plasma and the laser according to one aspect of the present invention includes (a), first, continuously providing an object to be welded, which has welding portions facing with each other; (b) pre-heating the welding portions with a plasma torch; and (c) irradiating a laser beam to the welding portions to weld the welding portion pre-heated by the plasma torch.

In the present invention, the plasma torch and the laser head are preferably aligned to have 0.5 to 2.5 mm of a distance between centers of heat input regions by the plasma torch and by the laser beam.

The welding method of the present invention is especially suitable to weld an object to be welded wherein the facing welding portions have a butt space of 0.2 mm or less.

The welding method of the present invention may be particularly suitably applied to the butt welding of stainless steel, as well as nickel alloy, copper, copper alloy, aluminum, aluminum alloy, titanium alloy, mild steel and low alloy steel.

In addition, the welding method may be suitably used to fabricate a metal tube having a relatively small thickness and diameter. That is to say, a method for fabricating a metal tube according to another aspect of the present invention includes (a) continuously providing a band-shaped metal sheet; (b) processing both ends of the metal sheet into a circular section so that both ends thereof face with each other; (c) pre-heating with a plasma torch a welding portion processed to have a circular section so that its both ends face with each other; and (d) irradiating a laser beam to the welding portions to weld the welding portions pre-heated with the plasma torch.

### BRIEF DESCRIPTION OF THE DRAWINGS

Other objects and aspects of the present invention will become apparent from the following description of embodiments with reference to the accompanying drawing in which:

FIG. 1 is a schematic perspective view showing a device for fabricating a metal tube using a welding method and a method for fabricating a metal tube according to an embodiment of the present invention;

FIGS. 2a and 2b are cross sectional views taken along lines A-A and B-B of FIG. 1, respectively;

FIGS. 3a and 3b are cross sectional views showing arrangement of a plasma torch and a laser head with respect to an object to be welded, and FIG. 3c is a cross sectional view viewed in a forward direction of the object to be welded so as to describe an angle between the plasma torch and laser head;

FIG. 4 is a plane view showing a welding portion and its surroundings so as to describe a welding method of the present invention;

FIG. 5 is a cross sectional view to describe an effect of a laser beam on multiple reflections generated in a V-shaped groove;

FIG. 6 is a cross sectional view to describe a penetration depth and a bead width;

FIGS. 7a and 7b are graphs showing relationships of a welding speed, a penetration depth and a bead width upon the welding using plasma alone;

FIG. 8 is a graph showing relationships of a welding speed, a penetration depth and a bead width upon the welding using laser alone; and

FIGS. 9a and 9b are graphs showing relationships of a distance between centers of heat input regions by two heat sources, a bead width and a penetration depth.

### BEST MODES FOR CARRYING OUT THE INVENTION

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

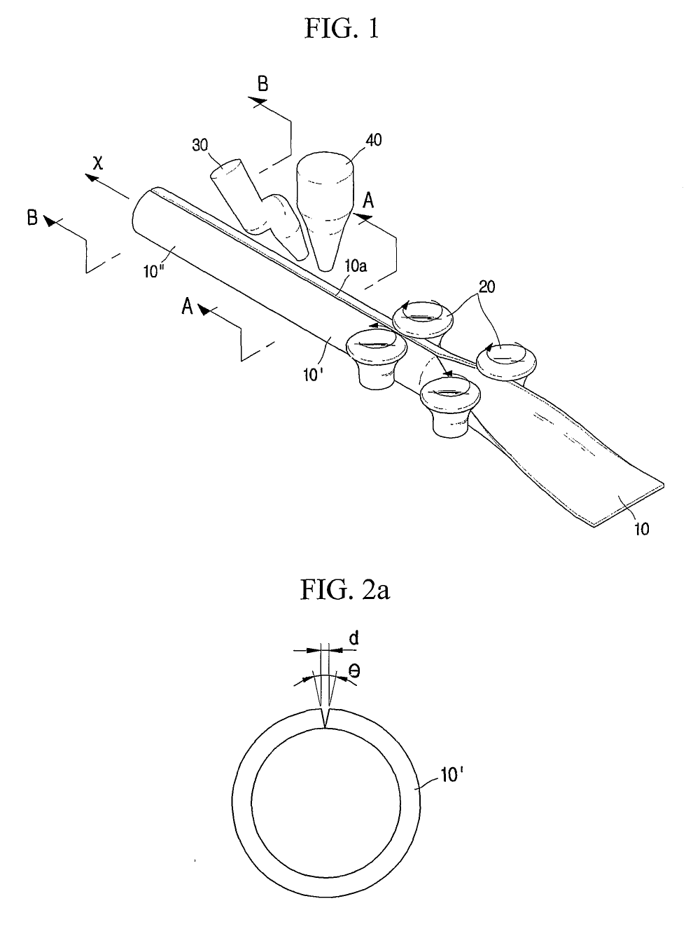

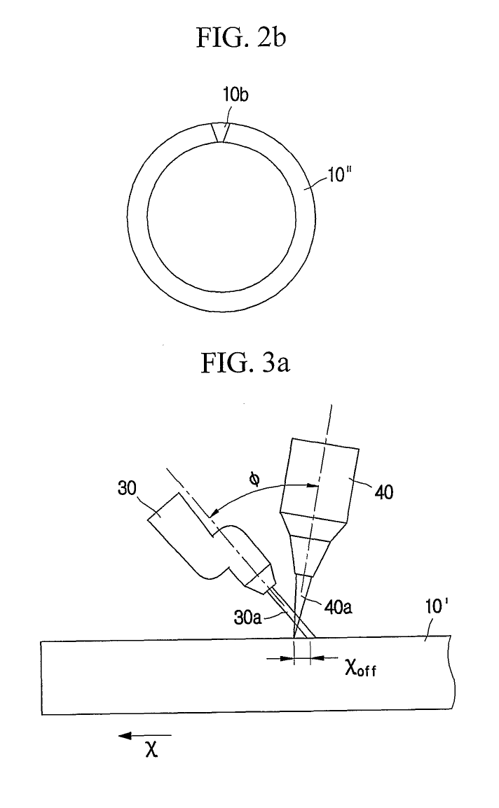

FIG. 1 is a schematic perspective view showing a device for fabricating a metal tube using a welding method and a method for fabricating a metal tube according to an embodiment of the present invention; and FIGS. 2a and 2b are cross sectional views taken along lines A-A and B-B of FIG. 1, respectively.

Referring to the FIGS. 1, 2a and 2b, a method for fabricating a metal tube is described according to this embodiment as follows. First, a metal sheet 10 having a constant width and a constant thickness is provided in the arrow x direction at a constant speed. And the metal sheet 10 is bent into a tube shape having a circular section by plasticizing both sides of the metal sheet 10 with a shaping unit 20. The metal tube 10′, which is shaped into a tube shape with a constant butt distance d as shown in FIG. 2a, is welded along a weld line 10a by a plasma torch 30 and a laser head 40 to fabricate a metal tube 10″ where welding portions are connected together, as shown in FIG. 2b. In the arrangement shown in FIG. 1, a feed speed of the metal sheet 10 is equal to the welding speed since the metal sheet 10 and the metal tube 10′, 10″ before and after welding integrally move and the shaping unit 20, the plasma torch 30 and the laser head 40 remain fixed. However, depending on arrangement of the device and, working conditions, it may be suitably selected which of the metal sheet 10, the shaping unit 20, the plasma torch 30 and the laser head 40 is fixed or moved. The feed speed and the welding speed of the metal sheet may also be varied if each of the metal sheet 10, the plasma torch 30 and laser head 40 moves independently.

In this embodiment, the metal sheet 10 is for example made of stainless steel having physical properties and dimensions as follows, but material and dimension of the metal sheet may be varied as desired, depending on those of a desired metal tube. That is to say, in addition to stainless steel, the metal sheet 10 may be made of nickel alloy, copper, copper alloy, aluminum, aluminum alloy, titanium alloy, mild steel, or low alloy steel. kks

Properties at normal temperature and dimensions of a metal sheet

Density: 7,200 kg/m³

Conductivity: 14.9 W/mK

Specific heat: 477 J/kgK

Melting point: 1,670 K

Latent heat of fusion: 247 kJ/kg

Boiling point: 3,000 K

Latent heat of vaporation: 7,000 kJ/kg

Thickness of the metal sheet: 0.2 mm

Width of the metal sheet: 13.5 mm

Diameter of a shaped metal tube: 4.3 mm

FIG. 1 shows the shaping unit 20 as two pairs of shaping rollers rotating with facing with each other, but the number of the roller pairs is not limited thereto. In this Embodiment, the shaping roller 20 is also designed to bend the metal sheet 10 into the metal tube with circular section, but the shaped metal tube 10′ may, for example, have an oval section.

In the metal tube 10′ bent into a tube shape by the shaping unit 20 before the welding, the facing welding portions form a V-shaped groove and have a butt space d of about 0.15 mm and an angle θ of about 10° in the V-shaped groove, as shown in FIG. 2a. But the butt space d and the angle θ may be varied depending on dimensions of the metal sheet 10 and a shape of the shaping unit 20. In particular, θ may be very small, preferably 5° or less.

Unlike a conventional arc welder, the plasma torch 30 used in the present invention may ensure the high-accuracy and high-density welding due to a narrow dispersion angle of the plasma. That is to say, the plasma welding is similar to TIG (Tungsten Inert Gas) welding, but the dispersion angle of the plasma may be more significantly narrower than that of the arc in the TIG welding because a tungsten welding rod is mounted inside a copper electrode in the plasma torch 30, and then gases are condensed due to the pilot gas to be added and the gas cooling effect of a water-cooled cooper nozzle. Also, efficiency of the plasma, so-called ratio of an electric power (heat), which is emitted at an end (a cathode) of the plasma torch 30 and then absorbed into a preform surface (an anode), is 60% or more, which is generally superior to the TIG welding having efficiency of 43%, and has low contamination and small corrosion of the welding rod. In this Embodiment, though a plasma welder of at most 80 A is used and a supply voltage is applied at 20 V to 30 V, but torches having different scales may be used depending on kinds and dimensions of the preform, or its welding speed.

Also, though a CO₂ laser welder having 680 W of a power output and about 0.5 mm of an effective diameter of the laser beam at a focus is used in this Embodiment, laser welders having different scales may be used depending on kinds and dimensions of the preform, or its welding speed.

Meanwhile, a welded metal tube 10″ as shown in FIG. 2 is manufactured by using the plasma torch 30 and the laser head 40 together to weld a metal tube 10′ along a weld line 10a in the present invention. But a positional relation, a distance x_{off} and an incidence angle between the plasma 30a by the plasma torch 30 and the laser beam 40a by the laser head 40 give serious influences on a welding speed and a welding product. Factors affecting the welding performance will be described in detail, as follows.

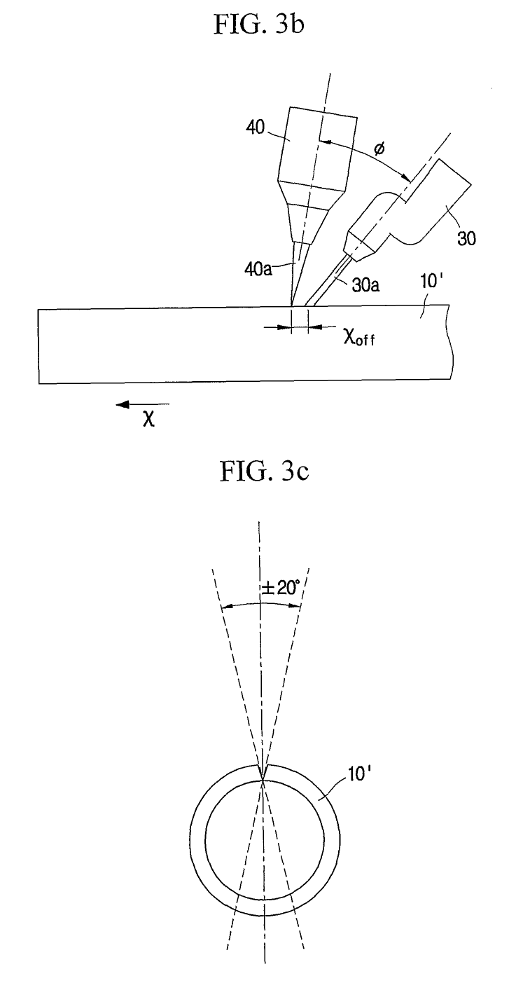

First, when used, the plasma torch 30 is inclined at about 45° against a surface of the preform 10′, as shown in FIGS. 3a and 3b. In this case, distribution of heat input energy by the plasma on the surface of the preform is described in detail.

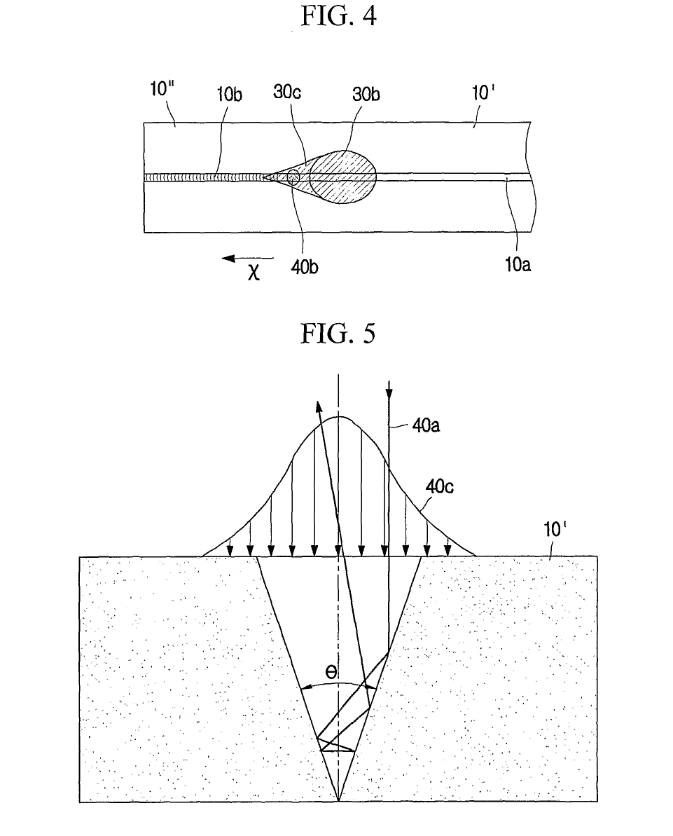

Though the heat input energy distribution I(r) by the plasma shows a Gaussian distribution as show in a following Equation 1 if the plasma 30a is incident perpendicularly onto a flat surface of the preform, the heat input region of the plasma (see 30b in FIG. 4) will become a long oval on the surface of the preform along a longitudinal direction x of the preform if the plasma 30a is incident onto the preform surface at an included angle. At this time, the heat input energy distribution is expressed in Equation 2.

$$I ( r ) = {I}_{0} exp ( - {c}^{2} \frac{{r}^{2}}{{r}_{0}^{2}} ) \qquad Equation 1$$

wherein, I₀ represents a peak energy density, r represents a radial distance in a heat input region, r₀ represents an effective radius of a heat input region, and c represents a degree of concentration where plasma energy is distributed within r₀. Meanwhile, a dispersion angle of the plasma is considered as a zero for calculation (namely, assuming the plasma as a column) since it is negligibly low in a following description.

$$I ( x , y ) = {I}_{0} sin {θ}_{t} exp [ - {c}^{2} ( \frac{{x}^{2}}{{a}^{2}} + \frac{{y}^{2}}{{b}^{2}} ) ] \qquad Equation 2$$

wherein, θₜ represents an incidence angle of the plasma, a represents a major axis length r₀/sin θₜ of the oval, b represents a minor axis length b=r₀ of the oval, x represents a distance in a major-axis direction from a center of the oval, y represents a distance in a minor-axis direction from a center of the oval.

Meanwhile, the Equations 1 and 2 represent an energy density when the plasma is incident onto a flat surface of the preform, but the plasma 30a is actually incident onto a V-shaped groove from its center in the case of this Embodiment. Accordingly, consideration should be taken into the heat input energy distribution of the plasma incident onto the interior of the V-shaped groove because it is very difficult to analyze the plasma since the plasma referred to as a flow of mass makes very complicated flows in the interior of the V-shaped groove. Accordingly, the heat input energy distribution in a wall surface of the V-shaped groove is here simplified to be constant in a forward direction of the plasma and to satisfy the Gaussian distribution in a traveling direction of the torch (actually, a traveling direction x of the preform). That is to say, it is assumed that the heat input energy density of the plasma is constant in a depth direction along the wall surface of the V-shaped groove.

The heat input energy distribution by the laser beam 40a of the laser head 40 is identical to that of the Equation 1 when the laser beam is incident perpendicularly onto a flat surface of the preform. However, consideration should be taken into the laser beam since it may be absorbed into or reflected from the surface of the preform. Absorptivity of the laser beam in the preform surface is varied depending on characteristics of the laser beam and quality or characteristics of the preform, but also depends on an incidence angle of the laser beam. According to an Fresnel formula of absorptivity, the laser beam shows the highest absorptivity if an incidence angle is 85° That is to say, the maximum absorptivity may be obtained if the laser beam is inclined toward the preform and then irradiated in near parallel with a surface of the preform. Here, it is noted that the laser head 40 should not be inclined in near parallel with the preform 10′ so as to obtain the maximum absorptivity, as in FIGS. 3a or 3b. As mentioned above, a welding portion of the preform 10′ of this Embodiment is a V-shaped groove having a butt distance d of about 0.15 mm, a majority of the laser beam 40a is irradiated into the V-shaped groove (see 40b of FIG. 4). Also, since the V-shaped groove has an included angel θ of about 10° as mentioned above, the incidence angle of the laser beam incident onto the wall surface of the V-shaped groove is nearly 85′ if the laser head 40 is aligned nearly perpendicularly to the surface of the preform 10′ in FIG. 3a or 3b. However, the laser head 40 is preferably aligned to be somewhat inclined as shown in FIGS. 3a and 3b because the laser beam irradiated onto the surface of the preform 10′ out of the V-shaped groove may be reflected to cause a damage to the laser head 40.

Meanwhile, when the laser beam is irradiated into the V-shaped groove as described above, an energy distribution input into the inner wall surface of the V-shaped groove is described in detail, based on the multiple reflection effect. That is to say, the laser beam 40a incident onto the V-shaped groove is multiple-reflected on the inner wall surface, and therefore only an extremely small quantity of its energy is reflected outside from the groove, as shown in FIG. 5. The frequency of multiple reflection in the interior of the V-shaped groove increases as an angle θ of the groove decreases. According to the calculation by inventors, the laser beam 40a incident onto the V-shaped groove is reflected 8 times if the groove has a angle θ of 20°. Absorptivity of the laser beam is changed upon each of 8 reflections of the laser beam since the incidence angle of the laser beam against the wall surface is changed in each of the 8 reflections, but the energy of the laser beam reflected outside from the groove by 8 reflections is reduced to less than 0.4% (0.5⁸≈0.0039) of the original input energy if absorptivity of the laser beam is approximately 0.5 as average upon one reflection. That is to say, it may be considered that the nearly all energy is absorbed into the V-shaped groove. Also, the frequency of reflection increases as the depth is increased along the wall surface of the V-shaped groove, and an energy density is highest in a central region of the heat input region 40b (see 40c of FIG. 5). Thus, heat input energy distribution in the interior of the V-shaped groove shows a pattern where the energy density has a maximum value in the lowest portion of the groove but gets smaller as it approaches to the upper portion.

Meanwhile, it was revealed from the experiments of the inventors that absorptivity (efficiency) of the total energy in the interior of the V-shaped groove is varied depending on the angle θ of the V-shaped groove (and therefore, depending on an incidence angle of the laser beam). For example the V-shaped groove shows efficiency of about 35% if it has the angle θ of 10°, a maximum efficiency at 20 to 40°, and efficiency of about 15% at 120° or more, which is nearly identical to that of a simple flat plate. It is seen from the above description that, as θ gets smaller, the frequency of the multiple reflection increases so that the efficiency should be higher, but the result as describe above comes from the fact that absolute incidence into the interior of the V-shaped groove is lowered since the ratio of incidence reaching the outside of the V-shaped groove in the heat input region 40b increases as the angle θ gets smaller.

The above description of the heat input energy distributions of the plasma and the laser is that each of the two heat sources was used alone. Total sum of the heat input energy distributions should be identical to a sum of each of the heat input energy distributions if two kinds of heat sources are used together but not interfered with each other.

In order to ensure an effect of interference on two heat sources, a simple test was carried out, as follows. First, only the laser beam is incident perpendicularly onto a flat surface of the preform so as to measure an energy incident onto a flat surface of the preform. At this time, the laser beam is defocused to form a focus slightly above the preform surface. Then, the plasma is overlaid on the focusing point of the laser beam to be perpendicular to the laser beam (namely, in parallel with the preform surface), and then the energy incident onto the preform surface is measured at this time. As a result, measured energy is 41 W when the laser beam is irradiated alone, and 40 W when it is interfered with the plasma. That is to say, it is revealed that the laser beam is somewhat, although slightly, absorbed into the plasma column if two heat sources are overlaid together. In addition, it is revealed that some distance x_{off} is preferably maintained between centers of the heat input regions 30b, 40b by two heat sources when two kinds of heat sources are used together, considering that this result is not measured when the laser beam and the plasma column was overlaid on the preform surface, namely that the welding was interfered when they were actually overlaid on the preform surface. However, it is preferred to avoid a distance x_{off} between two heat input regions from being extraordinarily increased because pre-heating effect is lowered in a preceding heat source if the distance x_{off} is extraordinarily increased. Optimum values of x_{off} may be varied depending on the process conditions such as powers of the plasma torch and the laser welder, a welding speed, etc. but definite values are calculated from an experimental embodiment, as described later.

Meanwhile, when two kinds of heat sources were used together, the heat input energy distribution is higher than that obtained when each of the heat sources were used alone if they were not interfered with each other, but total of the heat input energy distributions is preferably higher than a sum of each of the power input energy distributions. A synergy effect obtained by using two kinds of the heat sources together may be seen from the fact that absorptivity of the laser beam is increased due to the pre-heating with the plasma. That is to say, it is revealed from the above description that absorptivity of the laser beam is varied depending on the incidence angle of the laser beam against the preform surface, but absorptivity of the laser beam also additionally depends on temperature of the preform. In the case of stainless steel of this embodiment showing the physical properties, as described previously, an absorption coefficient is increased by about 3.5×10⁻⁵ per 1° C. in the Fresnel formula of absorptivity as described above. It may be revealed that, although this value is very slightly increased, it becomes significantly increased considering that the absorption coefficient of the laser beam is increased by 0.035, and the absorption coefficient at a room temperature is about 0.08, for example if temperature of the preform is increased by 1,000° C. due to the preheating with the plasma.

According to the description described above, it may be seen that the welding is preferably carried out to improve absorptivity of the laser beam by aligning the plasma prior to the laser at a suitable distance between two heat input regions, followed by pre-heating the preform if two kinds of heat sources are used together. The terms “aligning the plasma prior to the laser” means that the plasma 30a is first irradiated, and then laser beam 40a is irradiated as the preform 10′ is fed along the forward direction x. The plasma torch 30 and the laser head 40 may be aligned in an opposite direction to intersect (or cross) the plasma 30a and laser beam 40a, as shown in FIG. 3a, or the plasma torch 30 and the laser head 40 may be aligned in a parallel direction so as to irradiate the plasma 30a and the laser beam 40a in the parallel direction, as shown in FIG. 3b.

At this time, the included angle Φ between the plasma 30a and the laser beam 40a is preferably in the range of about 70° in FIG. 3a, and about 50° in FIG. 3b. Meanwhile, the outlet direction of the plasma 30a by the plasma torch and the irradiation direction of the laser beam 40a preferably have an angle of ±20 against the V-shaped groove (namely, weld line) of the preform 10′ when they are viewed in the forward direction of the preform 10′ (see FIG. 3c). It is because that the welding is carried out in a lopsided direction if the plasma 30a or the laser beam 40a is discharged or irradiated with an excessively inclined angle, finally causing an uneven surface of the welding portion or the incomplete welding.

As described above, if the distance x_{off} between the two heat sources, and the positional relation and the angle between the plasma torch 30 and the laser head 40 are suitably adjusted, the plasma 30a and the laser beam 40a are generated with a predetermined heat, and also the preform 10′ is continuously fed in a direction x, the heat input region 30b by the plasma 40a of the plasma torch 40 is first formed to pre-heat the preform, as shown in FIG. 4. As the preform proceeds, a pre-heating region 30c appears like a tail in the backward of the heat input region 30b by the plasma, and followed by the heat input region 40b by the laser beam 40a in the tail of the pre-heating region 30c. The main welding is carried out by melting the pre-heated preform in the heat input region 40b by the laser beam, and therefore beads 10b are generated continuously. Finally, the metal tube 10″ with a circular section is continuously manufactured from the metal sheet 10.

Hereinafter, it will be described that a welding performance is secured for the welding method of the present invention by means of the various experiments.

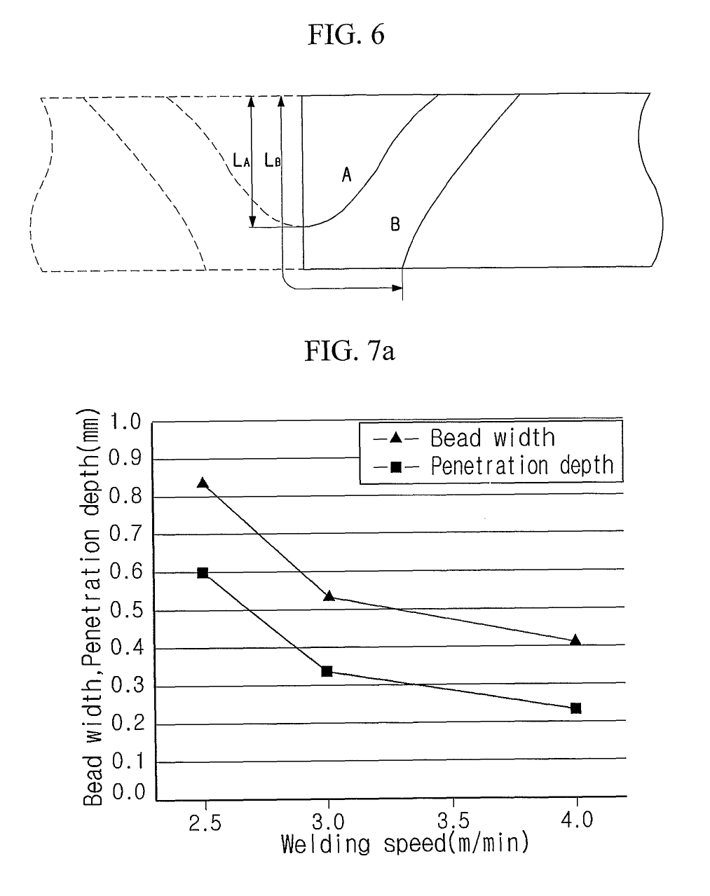

First, definitions of welding properties measured in following experiments are described in detail with reference to FIG. 6. FIG. 6 shows a half of a cross sectional view along the forward direction of the preform 10′. The welding performance may be evaluated by measuring other factors, but especially by measuring penetration depth L_{A} (also, referred to as a depth of a molten pool) and width L_{B} of a bead B.

In the following experiment, stainless steel described in the above-mentioned embodiment was used as the metal sheet, and an angle of the V-shaped groove was set to 10°. Also, the devices described in the above-mentioned embodiment were used as the plasma torch and the laser welder.

The following experiments are divided into three groups; the welding is carried out with only the plasma welder (Comparative embodiment 1) and with only the laser welder (Comparative embodiment 2), and the welding is carried out by using two kinds of heat sources together, provided that the plasma is aligned prior to the laser (Embodiment 1) or the laser is aligned prior to the plasma (Comparative embodiment 3). In the Comparative embodiments 1 and 2, the penetration depth and the bead width were measured by fixing the powers of the plasma and the laser, respectively, while varying the welding speed. And in the Embodiment 1 and Comparative embodiment 3, the penetration depth and the bead width were measured by fixing the welding speed, while varying the power of the plasma and the distance x_{off} between the two heat sources. The results are described, respectively, as follows.

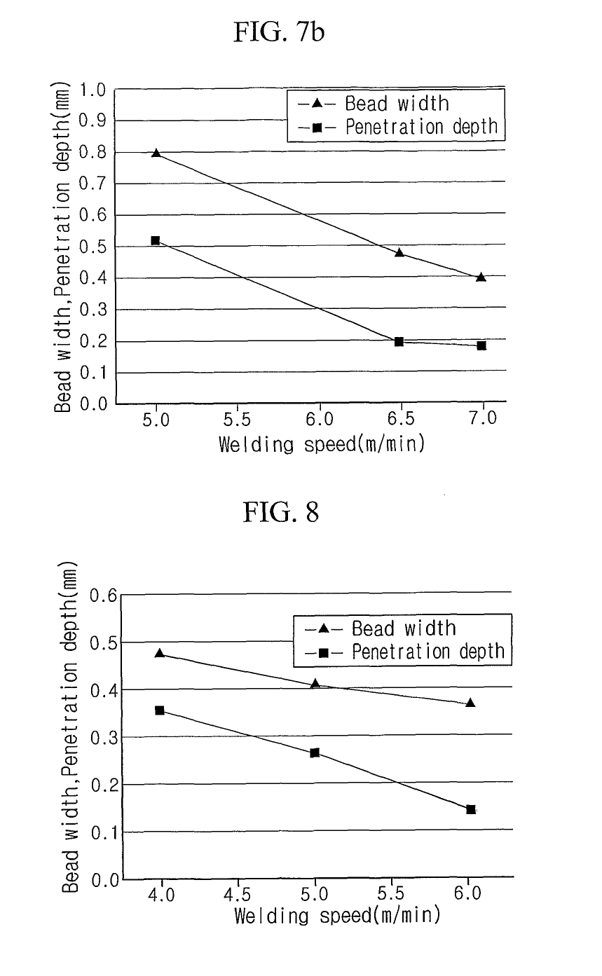

First, the result of the Comparative embodiment 1 shows that the penetration depth and the bead width decrease as the welding speed increases, as shown in FIG. 7a (the plasma current is fixed to 10 A) and FIG. 7b (the plasma current is fixed to 15 A). Assuming that a complete penetration is obtained if the penetration depth is at least 0.2 mm because the metal sheets used in these experiments have thickness of 0.2 mm, it may be seen that the complete penetration is obtained if the welding speed should be maintained at 4.0 m/min or less and 6.0 m/min or less in the FIGS. 7a and 7b, respectively.

In the Comparative embodiment 2 as shown in FIG. 8, it was revealed that the penetration depth and the bead width decrease as the welding speed increases, and the welding speed should be maintained at about 5.0 m/min or less for the complete penetration.

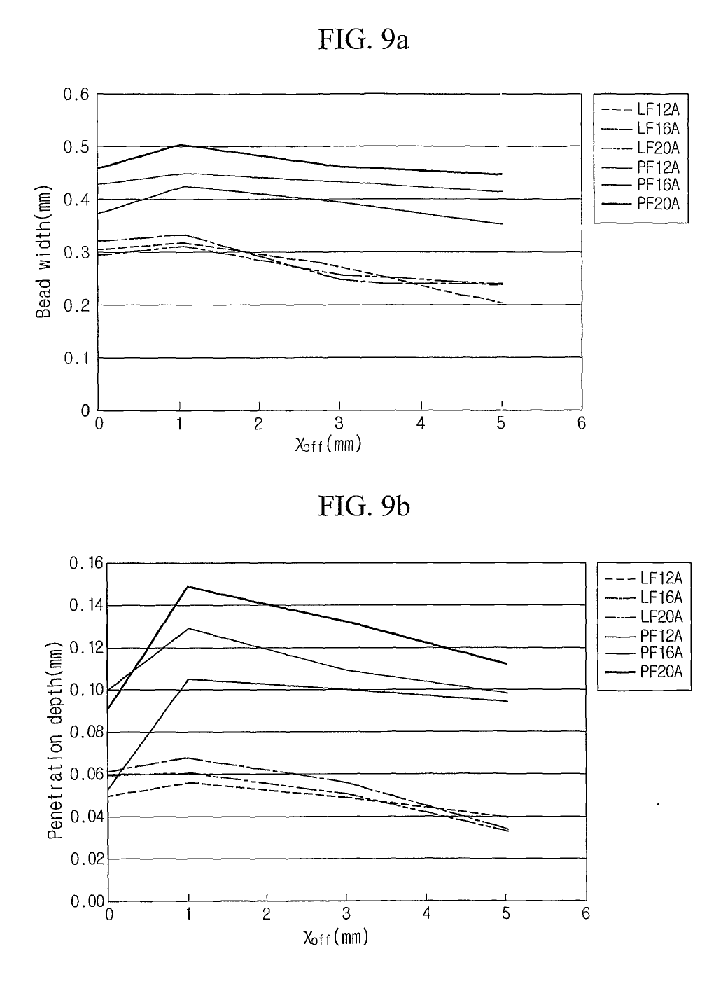

FIGS. 9a and 9b are graphs showing results of Embodiment 1 and Comparative embodiment 3, which show the bead width and the penetration depth measured by fixing the welding speed to 12 m/min and by varying the distance x_{off} between two heat sources. In FIGS. 9a and 9b, LF and PF mean that the laser is prior to the plasma, and the plasma is prior to the laser, respectively, and the next current value is meant to be a current applied in the plasma welder.

As shown in FIGS. 9a and 9b, it was revealed that the welding property of the Embodiment 1 where the plasma is prior to the laser is superior to that of the Comparative embodiment 3 where the laser is prior to the plasma when the two kinds of heat sources are used together. Also, it is confirmed that the welding property of the Embodiment 1 is more excellent if x_{off} ranges from 0.5 to 2.5 mm under the same conditions as in this experiment.

As described above, it may be seen from Embodiment 1 that the welding speed was increased to 12.0 m/min, which was higher than the respective welding speeds when a conventional plasma (6.0 m/min or less) or laser (5.0 m/min or less) is used alone, as well as than a simple sum of the respective welding speeds.

As described above, the present invention should be understood that though it has been described in detail with reference to the defined embodiments and figures, various changes and modifications will become apparent without departing from the spirit and scope of the invention. For example, the method of fabricating the metal tube was described in the above-mentioned embodiment by bending and welding a metal sheet, but the welding method of the present invention may be applied to other fields other than the metal tube.

Also, stainless steel is used as the preform (an object to be welded) in the above-mentioned embodiment, but the preform may be made of nickel alloy, copper, copper alloy, aluminum, aluminum alloy, titanium alloy, mild steel, low alloy steel, etc. In addition, though two facing metals of the object to be welded are identical since the metal sheet is bended to face with each other as described in the above-mentioned embodiments, the butt welding method of the present invention may be also applied to the different metals. Of course, the heats or the welding speeds of the plasma welder and the laser welder may be suitably varied according to kinds of the preforms if metals other than stainless steel or different metals are used as materials of the preforms in the butt welding.

Accordingly, the present invention should be understood that other equivalents and modifications could be made thereto without departing from the spirit and scope of the invention.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the welding property and the welding speed may be significantly improved when the object to be welded with a very small butt distance is butt-welded by pre-heating the object to be welded with the plasma torch, followed by carrying out the laser welding according to the welding method of the present invention. In particular, the very expensive laser welding machines is required for an accurate and rapid welding in the prior art, but the welding speed may be increased at a very low expense without a loss of the accuracy by using the plasma welding and the laser welding together. Further, if the laser welding is used alone, workability was reduced since it is difficult to trace the weld line accurately, but the workability and welding quality were improved if the laser welding and the plasma welding were used together. Also, because the welding method of the present invention may be applied to manufacturing the metal tube with a small thickness and diameter and therefore welding may be carried out at the same speed as the feed speed (a plastic processing speed) of the metal sheet, a bottle-neck operation may be solved upon manufacture of the metal tube, causing the productivity of the metal tube to be greatly enhanced.

What is claimed is:

1. A continuous butt welding method using plasma and laser, the method comprising;
(a) continuously providing an object to be welded, which has welding portions facing with each other;
(b) pre-heating the welding portions with a plasma torch; and
(c) irradiating a laser beam to the welding portions to weld the welding portions pre-heated by the plasma torch.

2. The continuous butt welding method using plasma and laser according to the claim 1, wherein the facing welding portions have a butt space of 0.2 mm or less.

3. The continuous butt welding method using plasma and laser according to the claim 1,
wherein a distance between centers of heat input regions by the plasma torch and by the laser beam ranges from 0.5 to 2.5 mm.

4. The continuous butt welding method using plasma and laser according to the claim 1,
wherein an angle between an outlet direction of the plasma by the plasma torch and an irradiation direction of the laser beam is 70° or less.

5. The continuous butt welding method using plasma and laser according to the claim 1,
wherein an angle between an outlet direction of the plasma by the plasma torch and an irradiation direction of the laser beam is within a range of ±20° against the welding portions when it is viewed in a forward direction of the object to be welded.

6. The continuous butt welding method using plasma and laser according to the claim 1,
wherein the object to be welded is one or two selected from the group consisting of stainless steel, nickel alloy, copper, copper alloy, aluminum, aluminum alloy, titanium alloy, mild steel and low alloy steel.

7. The continuous butt welding method using plasma and laser according to the claim 1,
wherein the object to be welded is supplied so that the welding portions form a section of a V-shaped groove to face with each other.

8. The continuous butt welding method using plasma and laser according to the claim 7, wherein the V-shaped groove has an included angle of 40° or less.

9. A method for fabricating a metal tube, comprising;
(a) continuously providing a band-shaped metal sheet;
(b) processing the metal sheet into a circular section so that both ends thereof face with each other;
(c) pre-heating with a plasma torch a welding portions processed to have a circular section so that both ends face with each other; and
(d) irradiating a laser beam to the welding portions to weld the welding portion pre-heated with the plasma torch.

10. The method for fabricating a metal tube according to the claim 9, wherein the facing welding portions have a butt space of 0.2 mm or less.

11. The method for fabricating a metal tube according to the claim 9,
wherein a distance between centers of heat input regions by the plasma torch and by the laser beam ranges from 0.5 to 2.5 mm.

12. The method for fabricating a metal tube according to the claim 9,
wherein an angle between an outlet direction of the plasma by the plasma torch and an irradiation direction of the laser beam is 70° or less.

13. The method for fabricating a metal tube according to the claim 9,
wherein an angle between an outlet direction of the plasma by the plasma torch and an irradiation direction of the laser beam is within a range of ±20° against the welding portions when it is viewed in a forward direction of the metal sheet.

14. The method for fabricating a metal tube according to the claim 9,
wherein the metal sheet is selected from the group consisting of stainless steel, nickel alloy, copper, copper alloy, aluminum, aluminum alloy, titanium alloy, mild steel and low alloy steel.

15. The method for fabricating a metal tube according to the claim 9,
wherein in the step (b) of processing to have the circular section, the metal sheet is processed so that the welding portions form a section of a V-shaped groove to face with each other.

16. The method for fabricating a metal tube according to the claim 15, wherein the V-shaped groove has an included angle of 40° or less.
